(19) United States
(12) Patent Application Publication
(10) Pub. No.: US 2012/0152656 A1
(43) Pub. Date: Jun. 21, 2012

(54) MULTI-CAGE ELEVATOR WITH BRAKING STATE INDICATION

(76) Inventor: Hans Kocher, Udligenswil (CH)

(21) Appl. No.: 13/314,710

(22) Filed: Dec. 8, 2011

(30) Foreign Application Priority Data
Dec. 16, 2010 (EP) 10195340.4

(51) Int. Cl. B66B 1/28; B66B 1/32

(52) U.S. Cl. 187/247; 187/288

(57) ABSTRACT

An elevator includes a first elevator cage, a second elevator cage, the two cages being movable along a common travel path, a braking state indicating unit, which is fastened to the first elevator cage, and a braking state detection unit, which is fastened to the second elevator cage. The braking state indicating unit indicates a braking state of the first elevator cage and the braking state detection unit detects the indicated braking state of the first elevator cage. When change in the braking state of the first elevator cage occurs, the braking state indicating unit initiates measures in order to maintain safe operation of the elevator.

### CROSS-REFERENCE TO RELATED APPLICATION

This application claims priority to European Patent Application No. 10195340.4, filed Dec. 16, 2010, which is incorporated herein by reference.

### FIELD

The present disclosure relates to an elevator with two independently movable elevator cages.

### BACKGROUND

The problem of collision protection often arises in the case of operation of elevators to with at least two elevator cages that are movable along a common travel path.

A safety system taking into account the above-mentioned problem is presented in European Patent Specification EP 0 769 469 B1. This safety system prevents a collision between the elevator cages in that the operating state of all moving elevator cages is constantly monitored. For this purpose the safety system knows the position and speed of each elevator cage at all times and, if a permissible safety spacing between two elevator cages in the course of travel is fallen below, the system has to be able to act on at least one of the two elevator cages making an impermissible approach to one another. In that case, for example, the permissible safety spacing is restored by a suitable braking measure.

The computing power of the safety system in the case of such a monitoring is relatively large, since the safety system also has to continuously know and evaluate the positions and speeds of elevator cages in normal operation of the elevator even when the permissible safety spacings between two elevator cages are maintained.

### SUMMARY

Some embodiments disclose a method of operating an elevator with a first elevator cage, a second elevator cage, the two cages being movable along a common travel path, a first braking state indicating unit, which is fastened to the first elevator cage, and a first braking state detection unit, which is fastened to the second elevator cage. In that case the method comprises the following process steps:
the first braking state indicating unit indicates a braking state of the first elevator cage and
the first braking state detection unit detects the indicated braking state of the first elevator cage and in the case of change in the braking state of the first elevator cage initiates measures in order to maintain a safe operation of the elevator.

By means of indication of the braking state by the first braking state indicating unit of the first elevator cage a potentially risky situation is indicated by the second elevator cage in simple mode and manner. If, for example, the first elevator cage undertakes braking, the second elevator cage could, without initiation of suitable measures, run into the first elevator cage.

If change in the braking state of the first elevator cage is detected, at least one computer unit is activated which checks the distance between the first and second elevator cages and, if a permissible safety distance is fallen below, acts at least on a travel parameter of the first elevator cage and/or the second elevator cage.

The computer unit can, for example, be designed as a central elevator control or as a non-central safety control arranged on the second elevator cage. Moreover, the computer unit can be constructed from a plurality of centrally or decentrally arranged control units which communicate with one another. In the case of such a construction, tasks based on division of work can be allocated to the individual control units. For example, a central control unit takes over controlling of the elevator cages in normal operation and several non-central safety controls, which are each associated with a respective elevator cage, monitor the spacing between the elevator cages and prevent a collision.

By reliable safety distance there is to be understood a distance between the two elevator cages which is still just sufficient in order to safely brake the second elevator cage without the second elevator cage running into the first elevator cage. The permissible safety distance is substantially dependent on the speed of elevator cages as well as the effectiveness of the influencing of a travel parameter of an elevator cage, thus, for example, how strongly an elevator cage travelling behind can be braked or how quickly an elevator cage travelling in front can be accelerated. The permissible safety spacing is thus possibly computed in the computer unit. Alternatively, for that purpose the permissible safety distance can also be fixedly predetermined and stored in the computer unit, wherein sufficiently large safety margins are taken into consideration in order to prevent a collision even in the least favorable case.

Possibly, selective activation of the computer unit means that the computer unit monitors the spacing between two elevator cages only when the second elevator cage makes a potential approach to the first elevator cage, for example if an elevator cage running in front brakes. The computer power, which is to be exercised, of the computer unit or the data exchange between participating systems can therefore be kept low.

In a further aspect of the method the elevator to be operated comprises at least a shaft information system which communicates with the computer unit. In this regard, the shaft information system communicates at least the position of the first and the second elevator cages to the computer unit. On the basis of these data the computer unit computes the current distance between the first and the second elevator cages and compares this with the permissible safety distance.

Apart from the position of the elevator cages in relation to a stationary reference system such as, for example, the travel path the shaft information system can also communicate the speed or the acceleration of the elevator cages to the computer unit. A permissible safety distance variable on a time basis is determinable by means of these additional data.

Each of the first and second elevator cages is usually driven by an associated first drive and second drive, respectively. In addition, each of the two first and second drives is equipped with an associated drive brake. Moreover, the first and second elevator cages are each equipped with a cage brake. In that case, drives, drive brakes and the cage brakes are each activatable indirectly or directly by the computer unit.

Some embodiments of the method particularly relate to an elevator in which the first and second elevator cages are moved with maintenance of a predominant travel direction. In that case the first of the cage travels in front of the second elevator cage in the direction of the predominant travel direction until all travel destinations in the predominant travel direction are served. The predominant travel direction is thereafter reversed.

If the permissible safety distance is fallen below, there is action, as described above, on at least one travel parameter of at least one of the two elevator cages. The action on the travel parameter concerns one or more measures for preventing a collision. These are the acceleration of the first elevator cage by the first drive, slowing down of the second elevator cage by the second drive, braking the second elevator cage by the associated drive brake and braking of the second elevator cage by the associated cage brake.

According to a further aspect of the method the first braking state indicating unit comprises at least one first light source and the first braking state detection unit comprises at least one first light-sensitive sensor region. In that case the first light source indicates a braking state of the first elevator cage by means of emitting at least one light effect and the first sensor region detects at least one of these light effects.

Switching-on and switching-off of the light source, lighting up the light source in different color tones, lighting up the light source with different light intensities, pulsation of the light source at different pulse frequencies and the like are, for example, suitable as light effects or indication of a braking state of the first elevator cage. For example, the light effect can also be used for the purpose of indicating the intensity of the form of braking underlying the braking state. Thus, for example, a slowing down of travel by means of the associated drive, an emergency stop by the associated drive brake or a safety braking by the associated cage brake can be indicated with increasing illumination intensity of the light source or differently assignable color tones.

### BRIEF DESCRIPTION OF THE DRAWINGS

The disclosed technologies are described in the following by exemplifying embodiments and a drawing, in which:

FIG. 1 shows an elevator with two elevator cages, wherein a first elevator cage is equipped with a braking state indicating unit and a second elevator cage is equipped with a braking state detection unit.

### DETAILED DESCRIPTION

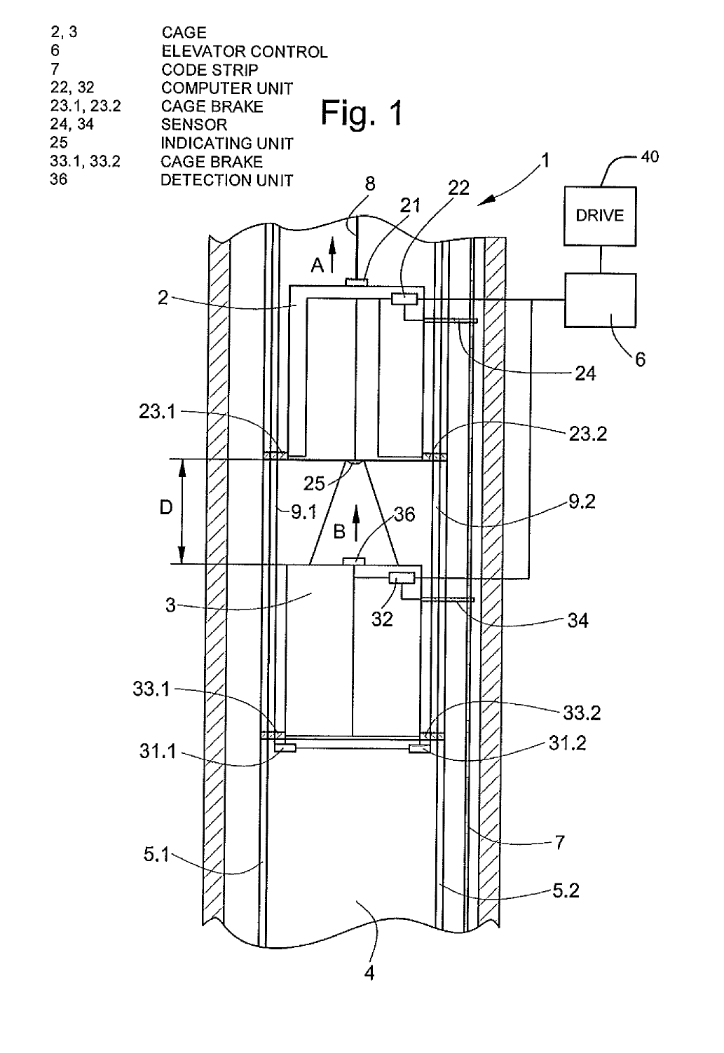

FIG. 1 shows an elevator 1 with at least two elevator cages 2, 3. Each of these elevator cages 2, 3 is independently movable substantially along a common travel path 4. In the illustrated example the travel path 4 is defined by a pair of cage guide rails 5.1, 5.2 installed in an elevator shaft.

The elevator cages 2, 3 are each suspended at a support means 8, 9.1, 9.2. In that case the suspension ratio, which is illustrated here, of 1:1 represents a common suspension ratio in elevator construction. However, one is free to select a higher suspension ratio of 2:1, 3:1 or higher differing therefrom.

The first elevator cage 2 is suspended at a first suspension point 21 at a first support means 8. The suspension point 21 possibly lies centrally on the upper side of the elevator cage 2. From the first suspension point 21 the support means runs upwardly into the upper region of the elevator shaft. There the first support means 8 runs over a first drive pulley. By means of the drive pulley and optional first deflecting rollers the first support means 8 is led down again to a first counterweight. The first counterweight is similarly suspended at the first support means 8 and balances the weight force of the first elevator cage 2.

A second elevator cage 3 is fastened at second and third suspension points 31.1, 31.2 to a second support means, which comprises two second support means runs 9.1, 9.2. The second elevator cage 3 is possibly suspended in its lower region on opposite sides at the two support means runs 9.1, 9.2. From the second and third suspension points 31.1, 31.2 these support means runs 9.1, 9.2 run laterally past the first elevator cage 2 upwardly to the upper region of the elevator shaft. There the second support means runs 9.1, 9.2 run over a second drive pulley. By means of the second drive pulley and optional second deflecting rollers the second support means runs 9.1, 9.2 are led downwardly again to a second counterweight. The second counterweight is finally similarly suspended at the second support means runs 9.1, 9.2 and balances the weight force of the second elevator cage 3.

The first and second drive pulleys are driven by a first drive and a second drive, respectively. The first and second drives transmit, by means of the respectively associated drive pulleys, a drive torque to the first and second support means 8, 9.1, 9.2. Correspondingly, the two elevator cages 2, 3 are movable substantially independently of one another by an associated drive. In addition, the first and second drives each have an associated drive brake.

In order to avoid a collision between the two elevator cages 2, 3 the elevator 1 is in addition equipped with a safety system. This safety system at least comprises braking state indicating means 25, braking state detection means 36 and a computer unit 22, 32. Each elevator cage 2, 3 is possibly associated with a computer unit 22, 32, a braking state indicating unit 25 and a braking state detection unit 36. For the sake of simplicity, however, only a first braking state indicating unit 25 of the first elevator cage 2, which runs in front in travel direction A, and a second braking state detection unit 36 of the second elevator cage 3, which runs behind in travel direction B, are respectively illustrated in FIG. 1.

Moreover, the elevator 1 comprises a shaft information system. This shaft information system comprises, for example, a code strip 7 with code marks and—per elevator cage 2, 3—a sensor 24, 34 for reading the code marks. The code strip 7 is mounted along the travel path in the shaft space. The code marks possibly represent a unique, non-confusable positional information.

In the illustrated example, associated with each elevator cage 2, 3 is a decentrally operating computer unit 22, 32 which is respectively connected with the braking state indicating unit 25, the braking state detection unit 36, the cage brakes 23.1, 23.2, 33.1, 33.2 and the sensors 24, 34 respectively associated with an elevator cage 2, 3. In addition, the computer unit 22, 32 communicates with a central elevator control 6 and is disposed in indirect communication by way of this with the first and second drives 40 as well as the associated drive brakes thereof. A respective computer unit 22, 32 also has, by way of the central control unit 6, data with respect to position and speed of the respective other elevator cage 3, 2.

The slowing down or braking of the elevator cage 2 running in front is carried out on the basis of different operational situations. For example, the travel of the elevator cage 2 running in front is slowed down by means of the associated drive on entry into a story. By contrast, in the case of an emergency stop the elevator cage 2 is braked by the associated drive brake. A fracture of the support means 8 even has the consequence of engagement of the associated cage brake 23.1, 23.2. Each of these braking maneuvers causes a change in the braking state of the first list cage 2.

Every slowing down or braking of the travel of the leading elevator cage 2 leads to a potentially risky approach of the following elevator cage 3, since the spacing between the two elevator cages shrinks. In the worst case the two elevator cages 2, 3 can, without resort to a suitable counter-measure, collide.

In order to prevent such an incident, the braking state indicator 25 indicates a change in the braking state of the elevator cage 2 running in front. The braking state indicator 25 is for that purpose equipped with, for example, a light source. A change in the braking state is then indicated by means of a light effect of the light source.

The braking state of the elevator cage 2 running in front is detected by the braking state detection unit 36 of the elevator cage running behind. For that purpose the braking state detection unit 36 is equipped with, for example, a light-sensitive sensor which detects the light effects emitted by the braking state indication.

One is free to use, instead of a transmitter/receiver pair designed for transmitting and receiving, respectively, optical waves such as, for example, the light source and the light-sensitive sensor, other transmitter/receiver pairs. Thus, further transmitter/receiver pairs can be used which can transmit and receive, respectively, for example, radio waves, acoustic waves, infrared waves or the like, by which a change in the braking state of the elevator cage 2 running in front can be indicated.

When a change in the braking state is detected by the braking state detection unit 36, the computer unit 32 is activated. The computer unit 32 checks the current distance D between the two elevator cages 2 and 3. For that purpose the computer unit 32 interrogates the shaft information system with respect to the current positions or speeds of the elevator cages 2 and 3.

The computer unit 32 compares the current distance D with a permissible safety distance. The permissible safety distance represents a spacing in which a safe braking of the following elevator cage 3 is still just possible. If this permissible safety distance is fallen below, than the computer unit 32 initiates a suitable measure in order to prevent a collision between the two elevator cages 2 and 3. This includes, at least, action on a travel parameter of the elevator cages 2, 3, namely:
acceleration of the travel of the leading elevator cage 2 by means of the associated drive;
slowing down of the travel of the trailing elevator cage 3 by means of the associated drive;
braking of the trailing elevator cage 3 by means of the associated drive brake; or
braking of the trailing elevator cage 3 by means of the associated cage brake 33.1, 33.2

The illustrated example relates to an instantaneous situation in which the upper elevator cage 2 runs in front in a direction A and the lower elevator cage runs behind in the same direction B of the upper elevator cage 2. At least some embodiments can equally well be used in a reversed travel direction in which the lower elevator cage 3 runs in front in a direction opposite to the direction B and the upper elevator cage 2 runs behind in a direction, which is opposite to the direction A, of the lower elevator cage 3. The lower elevator cage 3 can be similarly equipped with an individual braking state indicating unit which indicates a change in the braking state. Moreover, the trailing upper elevator cage 2 also has an individual braking state detection unit, by which a change in the braking state of the now leading second elevator cage 3 is detectable. A collision between the two elevator cages 2 and 3 is prevented analogously to the embodiments with a leading upper elevator cage 3.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator operation method, comprising:
indicating, using a braking state indicating unit fastened to a first elevator cage of an elevator, a braking state of the first elevator cage;
detecting, using a braking state detection unit fastened to a second elevator cage of the elevator, the indicated braking state of the first elevator cage, the first and second elevator cages being movable along a common travel path of the elevator; and
as a result of a change in the braking state of the first elevator cage, maintaining safe operation of the elevator using the braking state detection unit.

2. The elevator operation method of claim 1, further comprising:
as a further result of the change in the braking state of the first elevator cage, activating at least one computer unit;
determining, using the at least one computer unit, that a distance between the first and second elevator cages is below a permissible safety distance; and
as a result of the determining, preventing a collision of the first and second elevator cages.

3. The elevator operation method of claim 2, the elevator further comprising a shaft information system coupled to the at least one computer unit, the shaft information system communicating at least a position of the first elevator cage and a position of the second elevator cage to the at least one computer unit.

4. The elevator operation method of claim 2, the first elevator cage being coupled to at least one drive, the at least one drive being coupled to the at least one computer unit, the preventing the collision of the first and second elevator cages comprising accelerating a movement of the first elevator cage.

5. The elevator operation method of claim 2, the second elevator cage being coupled to at least one drive, the at least one drive being coupled to the at least one computer unit, the preventing the collision of the first and second elevator cages comprising decelerating a movement of the second elevator cage.

6. The elevator operation method of claim 5, the at least one drive comprising a drive brake, the drive brake being activatable by the at least one computer unit.

7. The elevator operation method of claim 2, the second elevator cage comprising a cage brake, the cage brake being activatable by the at least one computer unit.

8. The elevator operation method of claim 1, the braking state indicating unit comprising at least one light source, the braking state detection unit comprising at least one light-sensitive sensor region, the at least one light source being configured to indicate a braking state of the first elevator cage by emitting light for sensing by the at least one light-sensitive sensor region.

9. An elevator comprising:
a first elevator cage;
a second elevator cage, the first and second elevator cages being movable along a common path;
a braking state indicating unit, the braking state indicating unit being fastened to the first elevator cage;
a braking state detection unit, the braking state detection unit being fastened to the second elevator cage, the braking state indicating unit being configured to indicate a braking state of the first elevator cage, and the braking state detection unit being configured to detect the indicated braking state of the first elevator cage and to maintain safe operation of the elevator as a result of a change in the braking state of the first elevator cage.

10. The elevator of claim 9, further comprising at least one computer unit, the at least one computer unit being configured to determine a distance between the first and second elevator cages and compare the determined distance with a permissible safety distance.

11. The elevator of claim 9, the braking state indicating unit comprising at least one light source and the braking state detecting unit comprising at least one light-sensitive sensor region, the at least one light source being configured to indicate a braking state of the first elevator cage to the at least one light-sensitive sensor region.
